(19) United States
(12) Patent Application Publication
(10) Pub. No.: US 2024/0373412 A1
(43) Pub. Date: Nov. 7, 2024

(54) SPECTRUM MANAGEMENT OF OVERLAPPING BANDWIDTH

(71) Applicant: T-MOBILE INNOVATIONS LLC, Overland Park, KS (US)

(72) Inventors: Nagi A. MANSOUR, Arlington, VA (US); Akin OZOZLU, McLean, VA (US)

(21) Appl. No.: 18/313,172

(22) Filed: May 5, 2023

(51) Int. Cl. H04W 72/0457; H04L 5/00

(52) U.S. Cl. CPC H04W 72/0457; H04L 5/0092; H04L 5/0007

(57) ABSTRACT

Methods and systems for mitigating the effects of overlapping bandwidth parts are provided. A wireless communication network may determine that a first and a second bandwidth parts are overlapping. In response to the determination and prior to any communications being sent in the network, the network may proactively modify the first bandwidth part communications using an orthogonal code.

### TECHNICAL FIELD

The present invention relates to wireless telecommunications with antennas and radio frequency (RF) signal interference.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

In aspects set forth herein, a characteristic of one or more communications operating within a bandwidth portion is modified in response to a determination that a one or more bandwidth parts are overlapping. The overall band used at a particular cell can be congested as multiple users attempt to use a limited number of portions of the band. Allocating overlapping bandwidth parts consistent with the present disclosure alleviates said congestion. As such, methods and techniques described herein are used to provide for overlapping bandwidth parts using orthogonal coding.

### BRIEF DESCRIPTION OF THE DRAWINGS

The present technology is described in detail herein with reference to the drawing figures, which are intended to be exemplary and non-limiting in nature, wherein:

FIG. 1 depicts an exemplary computing environment suitable for use in implementation of the present disclosure;

FIG. 2 illustrates a diagram of an exemplary network environment in which implementations of the present disclosure may be employed;

FIG. 3 each depict an example diagram of a graphical representation of an overall band operating on a single cellular base station, in accordance with an embodiment of the present technology; and

FIG. 4 depicts a block diagram of an exemplary method of mitigating the effects of overlapping bandwidth parts, in accordance with an embodiment of the present technology.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms
3G Third-Generation Wireless Technology
4G Fourth-Generation Cellular Communication System
CD-ROM Compact Disk Read Only Memory
CDMA Code Division Multiple Access
eNodeB Evolved Node B
GIS Geographic/Geographical/Geospatial Information System
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MD Mobile Device
PC Personal Computer
PCS Personal Communications Service
PDA Personal Digital Assistant
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Transmission Receive Power
RSRQ Reference Transmission Receive Quality
RSSI Received Transmission Strength Indicator
SINR Transmission-to-Interference-Plus-Noise Ratio
SNR Transmission-to-noise ratio
SON Self-Organizing Networks
TDMA Time Division Multiple Access
UMTS Universal Mobile Telecommunications Systems

Further, various technical terms are used throughout this description. An illustrative resource that describes these terms may be found in Newton's Telecom Dictionary, 32nd Edition (2022).

A “mobile device,” as used herein, is a device that has the capability of using a wireless communications network, and may also be referred to as a “user device,” “wireless communication device,” or “user equipment (UE).” A mobile device may take on a variety of forms, such as a personal computer (PC), a laptop computer, a tablet, a mobile phone, a personal digital assistant (PDA), a server, or any other device that is capable of communicating with other devices using a wireless communications network. Additionally, embodiments of the present technology may be used with different technologies or standards, including, but not limited to, CDMA 1XA, GPRS, EvDO, TDMA, GSM, WiMax technology, LTE, and/or LTE Advanced, among other technologies and standards.

Embodiments of the technology may be embodied as, among other things, a method, a system, and/or a computer-program product. Accordingly, the embodiments may take the form of a hardware embodiment, or an embodiment combining software and hardware. In one embodiment, the technology may take the form of a computer-program product that includes computer-useable instructions embodied on one or more computer-readable media.

Computer-readable media may include both volatile media, non-volatile media, removable media, non-removable media, and contemplate media readable by a database, a switch, and/or various other network devices. Network switches, routers, and related components are conventional in nature, as are methods of communicating with the same. By way of example, and not limitation, computer-readable media may include computer storage media and/or communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and other storage devices. These memory components may store data momentarily, temporarily, and/or permanently.

Communications media typically store computer-useable instructions—including data structures and program modules—in a modulated data signal. The term “modulated data signal” refers to a propagated signal that has one or more of its characteristics set or changed to encode information in the signal. Communications media includes any information-delivery media. By way of example, but not limitation, communications media may include wired media, such as a wired network or direct-wired connection, and wireless media such as acoustic, infrared, radio, microwave, spread-spectrum, and other wireless media technologies. Combinations of the above are included within the scope of computer-readable media. Communications media do not include signals per se.

In cellular networks, the radio spectrum is divided into a set of frequency bands, which are further divided into channels or carriers that can be allocated to mobile devices for communication. One way to efficiently use the limited spectrum is to divide it into contiguous frequency bands, which can be allocated to different cells or base stations. Contiguous bandwidth partitioning is a technique used in wireless communication networks to allocate a range of contiguous frequency bands to a particular cell or base station in order to enhance its capacity and coverage.

When a mobile device establishes a connection with a serving cell, the cell allocates a certain amount of contiguous bandwidth to the device. The bandwidth allocation may depend on various factors such as the number of active users in the cell, the quality of the channel, and the available frequency spectrum. Contiguous bandwidth partitioning ensures that the allocated frequency bands are adjacent to each other and can be utilized efficiently by the serving cell without causing interference to other cells in the network. This technique allows for better utilization of the available spectrum, which is critical for providing high-quality wireless services to users.

When two users overlap in a bandwidth, it can lead to interference and degradation of service quality. This can happen in a number of ways, depending on the specific circumstances of the network and the users involved.

One common scenario is when two users are assigned to adjacent sub-bands within a larger carrier bandwidth. If the sub-bands are not sufficiently separated, the signals transmitted by the two users can interfere with each other, causing errors, dropouts, or reduced data rates. This is known as adjacent channel interference, and it can occur when the frequency separation between two channels is not wide enough to prevent signal leakage from one channel to the other.

Another way that two users can overlap in a bandwidth is when they are located in close proximity to each other. This can happen in situations where multiple users are accessing a single cell site, such as in densely populated urban areas or at large public events. When too many users are trying to access the same bandwidth resources, it can lead to congestion and interference, which can impact the performance of the entire network.

Orthogonal coding for overlapping bandwidth allocations is a novel technique to improve spectral efficiency and minimize interference between different users or services. Orthogonal coding refers to the use of different coding schemes or spreading sequences for different users or services in a wireless network. The coding schemes are designed to be orthogonal, meaning that they are mathematically independent of each other and do not interfere with each other when transmitted over the same frequency band. By using orthogonal coding, multiple users can share the same frequency band without causing interference or degradation of service quality.

Orthogonal coding is used herein to improve spectral efficiency and enable high-speed data services for multiple users simultaneously. For example, in a cellular network, orthogonal coding is used to enable multiple users to share the same frequency band without causing interference.

In one exemplary embodiment of the present technology, a system for mitigating the effects of overlapping bandwidth parts is provided. The system may comprise a first base station, and at least one processor. The processor may be configured to perform operations that comprise determining that a first wireless device is communicating with the first base station using a first bandwidth part (BWP). Additionally the operations performed may be determining that a second device is communicating with the first base station using a second BWP. Once the two BWPs are determined the system determines that at least a portion of the first BWP and the second BWP overlap and instructs the first wireless device to alter any outgoing communications to the first base station using an orthogonal code.

In another exemplary embodiment of the present technology, a method for mitigating the effects of a overlapping BWPs is provided. The method comprises comprise determining that a first wireless device is communicating with the first base station using a first bandwidth part (BWP). Additionally the operations performed may be determining that a second device is communicating with the first base station using a second BWP. Once the two BWPs are determined the system determines that at least a portion of the first BWP and the second BWP overlap and instructs the first wireless device to alter any outgoing communications to the first base station using an orthogonal code.

In yet another exemplary embodiment of the present technology, one or more computer-readable media having computer executable instructions embodied thereon are provided that, when executed, perform a method for mitigating overlap of BWPs. The method comprises comprise determining that a first wireless device is communicating with the first base station using a first bandwidth part (BWP). Additionally the operations performed may be determining that a second device is communicating with the first base station using a second BWP. Once the two BWPs are determined the system determines that at least a portion of the first BWP and the second BWP overlap and instructs the first wireless device to alter any outgoing communications to the first base station using an orthogonal code.

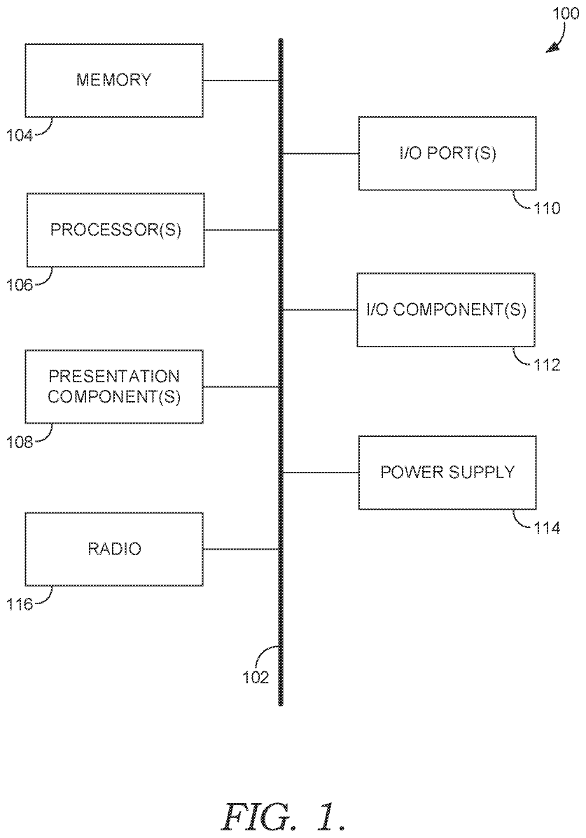

Referring to the drawings in general, and initially to FIG. 1, an exemplary computing environment 100 suitable for practicing embodiments of the present technology is provided. Computing environment 100 is but one example, and is not intended to suggest any limitation as to the scope of use or functionality of the embodiments discussed herein. Neither should the computing environment 100 be interpreted as having any dependency or requirement relating to any one or a combination of components illustrated. It should be noted that although some components in FIG. 1 are shown in the singular, they may be plural. For example, the computing environment 100 might include multiple processors and/or multiple radios. As shown in FIG. 1, computing environment 100 includes a bus that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 16 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 20 may be configured to support multiple technologies, and/or multiple radios may be configured and utilized to support multiple technologies.

The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 10.

Power supply 114 may include batteries, fuel cells, and/or any other component that may act as a power source to supply power to the computing environment 10 or to other network components, including through one or more electrical connections or couplings. Power supply 26 may be configured to selectively supply power to different components independently and/or concurrently.

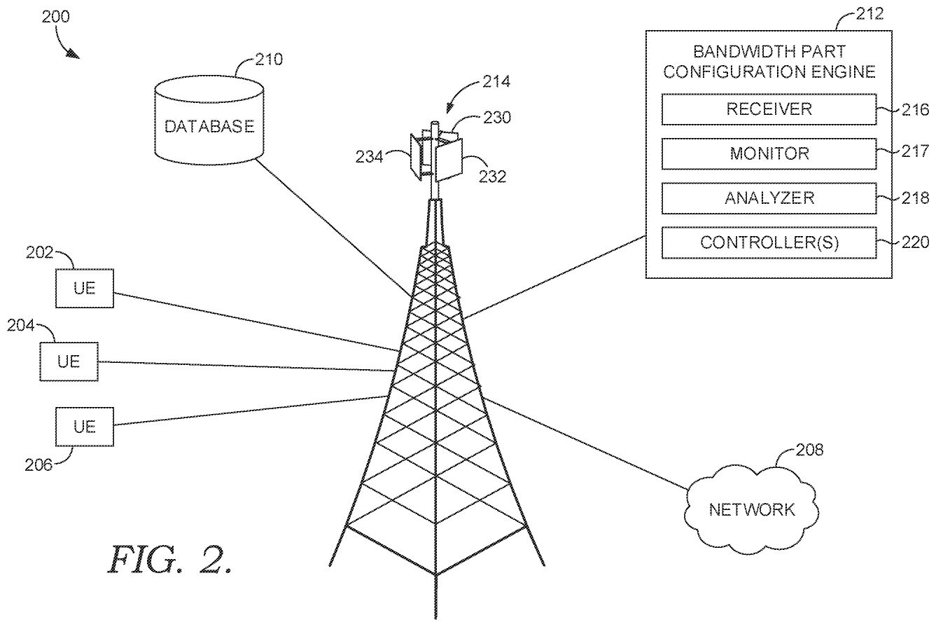

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and bandwidth part configuration engine 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, CDMA, or any other type of network.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1× circuit voice, a 3G network (e.g., CDMA, CDMA2000, WCDMA, GSM, UMTS), a 4G network (WiMAX, LTE, HSDPA), or a 5G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited geographical area. For the purposes of the present disclosure, it may be assumed that it is undesirable and unintended by the network 208 that the cell site 214 provide wireless connectivity to the user devices 202, 204, and 206 when the uses devices 202, 204, and 206 are geographically situated outside of the cell associated with cell site 214. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. In some aspects, the cell site 214 may comprise one or more macro cells (providing wireless coverage for users within a large geographic area) or it may be a small cell (providing wireless coverage for users within a small geographic area). For example, macro cells may correspond to a coverage area having a radius of approximately 1-15 miles or more, the radius measured at ground level and extending outward from an antenna at the cell site. In another example, a small cell may correspond to a coverage area having a radius of approximately less than three miles, the radius measured at ground level and extending outward from an antenna at the cell site.

As shown, cell site 214 is in communication with bandwidth part configuration engine 212, which comprises various components that are utilized, in various implementations, to perform one or more methods for identifying and determining if one or more bandwidth parts (BWP) s operating on a single cell are overlapping. Generally, the bandwidth part configuration engine 212 may implement various coding techniques to mitigate overlap of the overlapping BWPs. In some implementations, bandwidth part configuration engine 212 comprises components including a receiver 216, a monitor 217, an analyzer 218, and a controller 220. However, in other implementations, more or less components than those shown in FIG. 2 may be utilized to carry out aspects of the invention described herein. The components of bandwidth part configuration engine 212 may take any one or more of many forms, but specifically may comprise one or more processors and/or servers configured to perform the functions described herein.

The receiver 216 of the bandwidth part configuration engine 212 is generally responsible for receiving information from various user devices, such as the user devices 202, 204, and 206, when located within the coverage area of cell site 214. Information sent from a user device to the cell site 214 may comprise location information of the user device and channel quality information. Location information may comprise GPS or other satellite location services, terrestrial triangulation, an access point location, or any other means of obtaining coarse or fine location information. The location information may indicate geographic location(s) of one or more of a user device, an antenna, a cell tower, a cell site, and/or a coverage area of a cell site, for example. Channel quality information may indicate the quality of communications between one or more user devices and a particular cell site. For example, channel quality information may quantify how communications are traveling over a particular communication channel quality, thus indicating when communications performance is negatively impacted or impaired. As such, channel quality information may indicate a realized uplink and/or downlink transmission data rate of a cell site and/or each of one or more user devices communicating with the cell site, observed signal-to-interference-plus-noise ratio (SINR) and/or signal strength at the user device(s), or throughput of the connection between the cell site and the user device(s). Location and channel quality information may take into account the user device's capability, such as the number of antennas of the user device and the type of receiver used by the user device for detection. The receiver 216 may also be configured to receive information from devices within the coverage area such as bandwidth allocation and use. Additionally, the receiver may receive further information from user devices that indicate overlap of BWPs operating within the particular cell site's coverage area.

The monitor 217 is generally responsible for determining the bandwidth portions being used by the cell site 214. The monitor 217 identifies when a mobile device establishes a connection with a serving cell. That cell allocates a certain amount of contiguous bandwidth which is monitored by the monitor 217. The bandwidth allocation may depend on various factors such as the number of active users in the cell, the quality of the channel, and the available frequency spectrum. Contiguous bandwidth partitioning ensures that the allocated frequency bands are adjacent to each other and can be utilized efficiently by the serving cell without causing interference to other cells in the network. This technique allows for better utilization of the available spectrum, which is critical for providing high-quality wireless services to users. In such an example, the monitor 217 may additionally monitor the factors described above which may affect the bandwidth allocation.

The analyzer 218 is generally responsible for combining the information and/or indications from the receiver 216 with the information monitored by the monitor 217. For example, the analyzer 218 may receive an indication from the receiver 216 that more than one BWPs are being allocated within an area covered served by the cell site 214. The analyzer 218 may further receive information from the monitor 217 that the more than one BWPs have a particular allocated spectrum. The analyzer 218 may determine whether the spectrum from one BWP and a second BWP overlap. In aspects, this determination may be made by determining whether the frequency of the spectrum for a first BWP is overlapping a second frequency for a second BWP.

The controller 220 is generally responsible for executing a BWP overlap reduction strategy, in embodiments. When the controller 222 is configured to receive information from the analyzer that there are two BWPs within the coverage area of the cell site, the controller 220 may communicate information to the user devices which operate within the cell site coverage area. Those instructions may indicate that a user device operating on one of the overlapping BWPs. Those instructions may indicate that a user device must multiplex a communication signal with an orthogonal code prior to transmitting a communication signal to the cell site. Further, the controller 220 may also provide instructions to the cell site after the analyzer 218 has determined that a first BWP and a second BWP overlap. The Controller 220 will indicate that the cell site must multiplex a communication signal that is operating on the first BWP or the second BWP with an orthogonal code prior to transmitting a communication signal to the user device. The controller 220 is also able to instruct both the user device operating on the first BWP and the cell site to multiplex the signal using an orthogonal code.

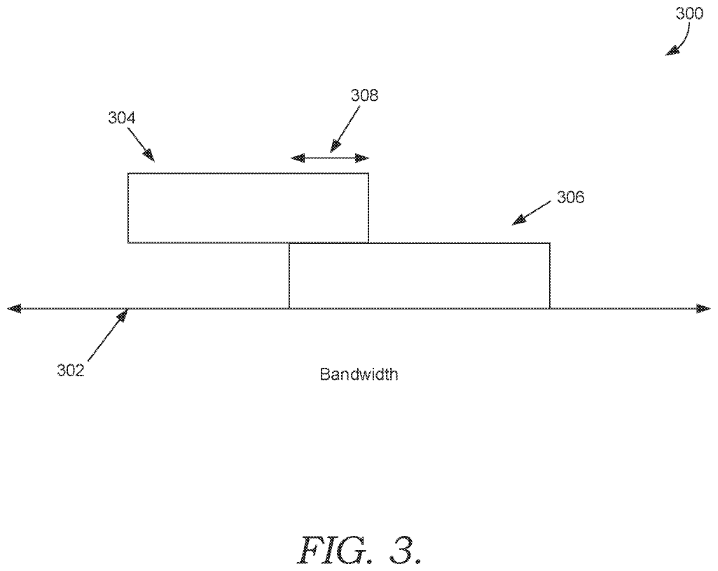

Turning now to FIG. 3, a exemplary diagram 300 describing the operation of two or more bandwidth allocations within a particular cell site. A single operator provides service over the same overall band 302. The overall band 302 may comprise any number of bandwidth allocations for user devices operating within the cell site. Those devices may be operating using LTE, 5G, 6G, or any other communication protocol. The diagram 300 depicts a first BWP 304 and a second BWP 306 used by one or more UEs and a base station to wirelessly communicate.

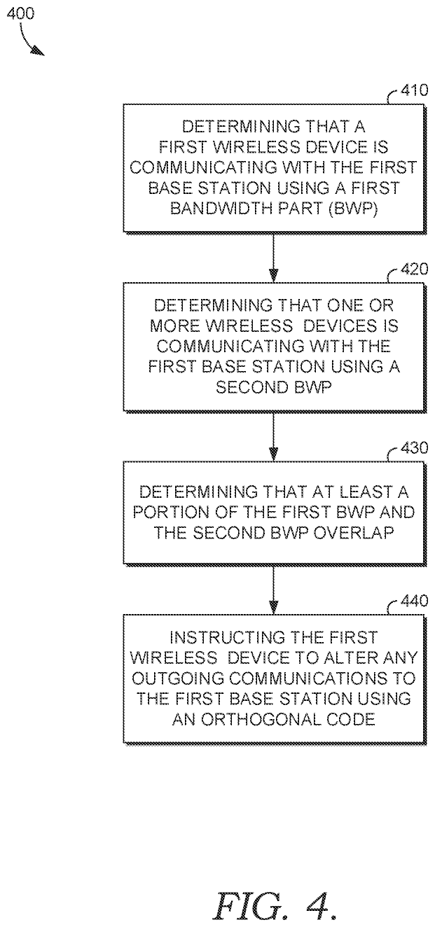

In the illustrated example diagram 300, the first BWP 304 and the second BWP 306 overlap at least a first overlapping portion 308 of the overall band 302. This overlap 308 may be small or large depending on the bandwidth allocation within the cell site. The cell site may intentionally overlap bandwidth parts to more effectively use the entire overall band 302. As such, the overlapping portion 308 may be known. Additionally, the overlapping portion 308 may be detected by the system described in FIG. 2. For example, the cell site may identify that a high amount of interference is occurring with the first BWP 304 and the second BWP 306. The cell site may then determine that the first BWP 304 and the second BWP 306 overlap bandwidths. The cell site may then perform operations of FIG. 4 by the access node or any other network component operating within the network environment of FIG. 2.

Turning now to FIG. 4, an exemplary method 400 for mitigating the effects of overlapping bandwidth part is presented. At step 410, it is determined that a first wireless device is communicating with the first base station using a first bandwidth part (BWP). The cell site may assign the first user device to the first BWP after the user device enters the coverage area of the cell site. Additionally, if the user device switches from one protocol such as 4G to a second protocol such as 5G, the cell site may determine that the user device is operating on a different BWP or multiple BWPs.

At a second step 420, it is determined that a second device is communicating with the first base station using a second BWP. The cell site may assign the first user device to the second BWP after the second user device enters the coverage area of the cell site. Additionally, if the user device switches from one protocol such as 4G to a second protocol such as 5G, the cell site may determine that the user device is operating on a different BWP or multiple BWPs. These assignments or determinations may be based on the number of user device operating within the cell site's coverage. At step 430, it is determined that at least a portion of the first BWP and the second BWP overlap. The cell site may intentionally assign overlapping BWPs based on an excess number of user devices operating within the cell site coverage area.

At step 440, instructions are provided to the first wireless device to alter any outgoing communications to the first base station operating using the first BWP. The instruction includes altering the outgoing communications by encoding the outgoing transmissions using an orthogonal code prior to transmission. The transmission from the user device is then decoded by the base station using the orthogonal code. The orthogonal code may be a code division multiplexing code. The orthogonal code may also be any other orthogonal code that may allow for the transmission of communication over the first BWP and the second BWP without interference. The step 440, may also instruct the cell site to alter any outgoing communications operating on the first BWP by multiplexing the signal using orthogonal code. Transmissions from the cell site to the first user device are then separated from the orthogonal code after reception by the first user device. In one additional aspect, the orthogonal code is a code division multiplex code. Additionally, the second user device operating on the second BWP may be instructed to communicate uplink signals without any encoding. Further, the second user device may be instructed to encode the uplink signals using a second orthogonal code.

Many different arrangements of the various components depicted, as well as components not shown, are possible without departing from the scope of the claims herein. Embodiments of the technology have been described with the intent to be illustrative rather than restrictive. Alternative embodiments will become apparent to readers of this disclosure after and because of reading it. Alternative methods of implementing the aforementioned subject matter may be performed without departing from the scope of the claims herein. Certain features and sub-combinations are of utility and may be employed without reference to other features and sub-combinations, which is contemplated as within the scope of the claims.

What is claimed is:

1. A system comprising:
a base station comprising a first antenna; and
one or more computer processor components configured to perform operations comprising:
determining that a first wireless device is communicating a first uplink signal to the first base station using a first bandwidth part (BWP);
determining that a second device is communicating a second uplink signal to the first base station using a second BWP;
determining that at least a portion of the first BWP and the second BWP overlap; and
instructing the first wireless device to encode the first uplink signal using an orthogonal code.

2. The system of claim 1, further comprising instructing the base station to encode a first downlink signal to the first wireless device using the orthogonal code.

3. The system of claim 2, wherein the base station is configured to decode the first uplink signal using the orthogonal code.

4. The system of claim 1, wherein the encoding of the first uplink signal is done by multiplexing the first uplink signal using the orthogonal code.

5. The system of claim 1, wherein the first BWP and the second BWP have a same and a same carrier.

6. The system of claim 1, wherein the orthogonal code is a code division multiplexing code.

7. The system of claim 1, wherein the second BWP is encoded using a second orthogonal code.

8. The system of claim 1, wherein the second wireless device is instructed to leave any uplink signals un-encoded.

9. A method comprising:
determining that a first wireless device is communicating a first uplink signal to the first base station using a first bandwidth part (BWP);
determining that a second device is communicating a second uplink signal to the first base station using a second BWP;
determining that at least a portion of the first BWP and the second BWP overlap; and
instructing the first wireless device to encode the first uplink signal using an orthogonal code.

10. The method of claim 9, further comprising instructing the base station to encode a first downlink signal to the first wireless device using the orthogonal code.

11. The method of claim 10, wherein the base station is configured to decode the first uplink signal using the orthogonal code.

12. The method of claim 9, wherein the encoding of the first uplink signal is done by multiplexing the first uplink signal using the orthogonal code.

13. The method of claim 9, wherein the first BWP and the second BWP have a same and a same carrier.

14. The method of claim 9, wherein the orthogonal code is a code division multiplexing code.

15. One or more computer-readable media having computer-executable instructions embodied thereon that, when executed, perform a method comprising:
determining that a first wireless device is communicating a first uplink signal to the first base station using a first bandwidth part (BWP);
determining that a second device is communicating a second uplink signal to the first base station using a second BWP;
determining that at least a portion of the first BWP and the second BWP overlap; and
instructing the first wireless device to encode the first uplink signal using an orthogonal code.

16. The media of claim 15, further comprising instructing the base station to encode a first downlink signal to the first wireless device using the orthogonal code.

17. The media of claim 16, wherein the base station is configured to decode the first uplink signal using the orthogonal code.

18. The media of claim 15, wherein the encoding of the first uplink signal is done by multiplexing the first uplink signal using the orthogonal code.

19. The media of claim 15, wherein the first BWP and the second BWP have a same and a same carrier.

20. The media of claim 15, wherein the orthogonal code is a code division multiplexing code.
